(19) United States
(12) Patent Application Publication
(10) Pub. No.: US 2006/0027611 A1
(43) Pub. Date: Feb. 9, 2006

(54) Baffled water bottle

(76) Inventor: Wade Travis Hobbs, Charlotte, NC (US)

Correspondence Address: Michael T. Cash, Esq., 11108 Eagle Trace Drive, New Market, MD, 21774, US

(21) Appl. No.: 10/897,704

(22) Filed: Jul. 23, 2004

(51) Int. Cl. B67D 3/00

(52) U.S. Cl. 222/564

(57) ABSTRACT

The invention is a water bottle intended primarily for distance athletes such as long distance runners. Internal to the water bottle is a series of baffles whose main body surfaces are located perpendicular to the longitudal (long) axis of the water bottle. The baffles are attached to the inner walls of the water bottle. The baffles are sufficiently rigid to arrest fluid motion minimizing the noise of water sloshing and energy loss due to fluid motion. The baffles are structurally attached to the water bottle in a manner that requires no central connecting structure and in a sufficiently rigid manner to arrest fluid motion during high intensity athletic events. The design may also incorporate a longitudinal baffle connected at near right angles to the previously described baffles or connected to partial baffles. Finally, the design may incorporate baffles that are non-planar (cup shaped).

### BACKGROUND OF THE INVENTION

1. Field of the Invention

According to Greek legend, Philippides ran 24 hilly miles from Marathon to Athens on a hot summer's day in 490 BC. He ran to deliver the message that the Athenian Army had defeated the Persians. Totally exhausted, he died after the good news reached the city. This legend is said to have inspired the modern marathon in the Olympic Games. The first modern marathon was held in 1894 as a 26 mile race from Marathon to Athens commemorating the Greek Legend.

Since these early beginnings long distance running has emerged as one of the largest participant sports in the world and the United States. Long distance running covers far more than the traditional 26 mile marathon, everything from 5 kilometer races to the ultra-endurance 100 mile runs such as the “Western States Endurance Run” which is going into its 31^{st} year. In addition, other long distance and endurance sports such as the triathlon have emerged as popular participant sports in the United States. To participate in these long distance events athletes undertake extensive training, often training months or even years for a critical race. Other runners and long distance athletes do not compete, but undertake the sports as part of their lifestyle or as a health maintenance activity. These individuals also spend significant time running during routine exercise or during an occasional competitive event.

One of the elements of long distance running, whether for enjoyment or for competition is the proliferation of specialized equipment, from shoes to shorts and everything in between. One of the most important functions for equipment during running is the need for maintaining sufficient hydration during running. If hydration of the body is not sufficiently maintained the runner's performance will suffer and injury from heat illness or even in rare circumstances a fatality could result. Consumption of water or specially formulated sports drinks is the only means of avoiding dehydration during distance running. One source indicates that 20 to 40 ounces of fluid should be consumed per hour during such events. This consumption requirement dictates the need for some means of transporting the fluid with the athlete while running.

2. Brief Description of Related Art

The importance of maintaining hydration during running has resulted in the proliferation of water bottle designs for distance runners. The basic concepts common in the existing designs are, (1) light weight materials, (2) capable of use without stopping to drink, (3) drinking spouts that avoid spillage and (4) a means of holding the bottle while not in use. These water bottles often come with a means of attaching the water bottle to the runner's waist U.S. Pat. No. 6,004,033 (Cirone) or in other designs a number of water bottles carried on the upper body. A form of this latter type of bottle based hydration system can be found in U.S. Pat. No. 6,241,135 (Thatcher).

More recent technology has emerged sometimes referred to as “hydration systems” based on some form of bladder system such as in U.S. Pat. No. 6,666,360 (Swank). One of the problems with the traditional water bottle system, recognized in Swank, is the effect of the fluid motion caused by the swaying motion of the runner's body. As the runners body sways in one direction, the fluid in the bottle is accelerated in the direction of the sway until the water mass is arrested by the impact with opposing surfaces of the bottle. This fluid motion results in the annoying “sloshing” sound which everyone is familiar.

For long distance running however, a more important concern arises from this motion. The liquid motion consumes small increments of the runner's energy each time the fluid mass momentum is arrested against an inner surface of the water bottle. The fluid mass imparts a momentum force against the bottle inner surface, which the runner's body must oppose with a reaction force in opposition to the momentum force. Each time the fluid mass imparts a momentum force inside the water bottle some composition of that force is most likely to act in opposition to the runner's motion. Each time a component of this force acts against the runner's motion, the runner uses some small increment of energy to counteract that motion. Although the energy use per motion may be small, the affect compounds over a long distance event where a runner takes thousands upon thousands of strides.

The Swank bladder system places a bladder close to the body of the runner to eliminate to a substantial degree the affect of body motion of the runner. However, in achieving this goal the system requires a complex design consisting of numerous components such as a bladder, a check valve nozzle, a quick-connect socket, an outlet check valve and tubing. Such a system is inherently more costly than a simple water bottle and subject to certain malfunctions, such as a faulty check valve which a water bottle is not subject.

In a related area focused on hunters, hikers and campers U.S. Pat. No. 6,588,622 (Leishman) introduces baffles into a water bottle to eliminate the sloshing sound of fluid motion while hiking or hunting. The focus of Leishman is on the sound caused by the water movement and employs a removable baffle system which arrests the fluid motion and thereby addresses the movement of the fluid without the complexities of the Swank hydration bladder. However, the removable Leishman baffle system is relatively complex in design incorporating a central tubular core with this hollow core attached to fins. In addition, the removable baffle structure, while sufficient for noise reduction during hiking or hunting lacks sufficient stability necessary for fluid motion during long distance running. In addition, the design does not address the need to drink while on the move during competitive running.

Another baffle system is Rookard (U.S. Pat. No. 4,272,768) which is designed to address the “pendulum” like motion associated with individual's motion while wearing a canteen. In addition, this canteen sought to achieve other purposes not relevant to long distance running such as flotation and heat insulating properties. Because of these design objectives the baffle system developed in Rookard is complex, heavy and divides a canteen into a number of compartments. The baffles form a series of interconnected plates which results in an effective baffle system, yet one clearly not suitable for long distance running because of the weight. In addition, there has been no accommodation in the design to allow for quick use by a runner engaged in running.

Another baffle system for canteens Sucato (U.S. Pat. No. 4,550,848) was also developed with a focus on campers, hunters and hikers. In Sucato the baffle consists of a number of resilient plates interconnected each plate running parallel to the longitudal axis of the canteen. The baffles are removable and can be rolled up to allow for cleaning of the canteen and the baffles. While this design is sufficient for noise reduction associated with hiking or camping, the design is not sufficiently rigid to address water motion to the degree necessary under the more vigorous motion for running. In addition, the design makes no accommodation for the need for runners to drink while running.

### OBJECTS OF THE INVENTION

Over the years various innovations in water bottle or hydration systems have emerged for the purposes of maintaining distance runners performance and health during long distance events. In addition, some canteen designs have addressed water slosh noise using baffles in the canteen. As far as it is known, prior to this invention no one has been successful in providing a water bottle which is (1) constructed of light weight materials, (2) can be used without stopping to drink, (3) employs drinking spouts that avoid spillage, (4) is easily worn or carried (5) provides a simple means of minimizing noise of water slosh and the associated energy loss from water motion during running and has (6) sufficiently rigid baffles to reduce water motion forces during running events.

This invention accomplishes all of these goals in new and unexpected ways and results in a water bottle which is simple in construction, light weight, easily carried in typical distance athletes water bottle holders and minimizes water motion noise and energy loss. From the runners perspective the water bottle is no different to use than any other standard water bottle eliminating any concern for potential malfunction of valves or other complex equipment.

### SUMMARY OF THE INVENTION

The invention is a water bottle intended primarily for distance athletes such as long distance runners. The water bottle employs a baffle system directly attached to the body of the water bottle. The design can be either for a water bottle that is a rigid body or a semi-rigid body. Through the selection of light weight water bottle materials and light weight baffle materials, the bottle remains lightweight for use in distance running.

Because the baffles are rigid or semi-rigid and directly attached to the inner wall of the water bottle with the surface of the baffles perpendicular to the longitudal axis of the water bottle there are a limited number of baffles necessary and the design is robust enough to arrest fluid motion. In the semi-rigid water bottle design the baffles are semi-rigid and are attached and geometrically oriented to allow the athlete to easily squeeze the bottle to drink. The baffles are sufficiently rigid however to arrest fluid motion minimizing the noise of water sloshing and energy loss due to fluid motion. In an alternative design there are baffles longitudinal to the axis of the water bottle, connected to the remaining baffle plates or partial baffle plates. In an alternative design the baffles are non-planar (cup shaped).

### BRIEF DESCRIPTION OF THE DRAWINGS

FIG. 1 is a general arrangement of the water bottle, showing a representative placement of baffles [3] within the main body [1] of the water bottle.

FIG. 2 shows some detail of the orientation of a representative baffle [3] located within the water bottle with a representative number of baffle openings [4].

FIG. 3 shows baffle [3] to main body [1] attachment details using a representative baffle receptacle [6].

FIG. 4 shows baffle [3] to main body [1] attachment details using a representative baffle ledge pair [10].

FIG. 5 shows baffle [3] to main body [1] attachment details using a representative direct attachment with either fusing, adhesive or integral construction.

FIG. 6 shows an alternative baffle system, where additional longitudal baffles [11] are located parallel to the longitudal axis of the water bottle. The longitudal baffles [11] are connected to a top baffle [12] and a bottom baffle [13] and a number of other representative baffles [3] in an orientation perpendicular to the longitudal axis.

FIG. 7 shows an alternative baffle system, where and additional longitudal baffle [11] is located parallel to the longitudal axis of the water bottle. The longitudal baffle is connected to a top baffle [12] and a bottom baffle [13]. A number of other representative half baffles [14] are attached to the longitudal baffle [11] at staggered axial locations along the longitudal axis of the water bottle.

FIG. 8 shows and alternative baffle system, where non-planar baffles [15] are incorporated into the design in a manner similar to FIG. 1 and FIG. 2, with elongated openings [16] in the baffles.

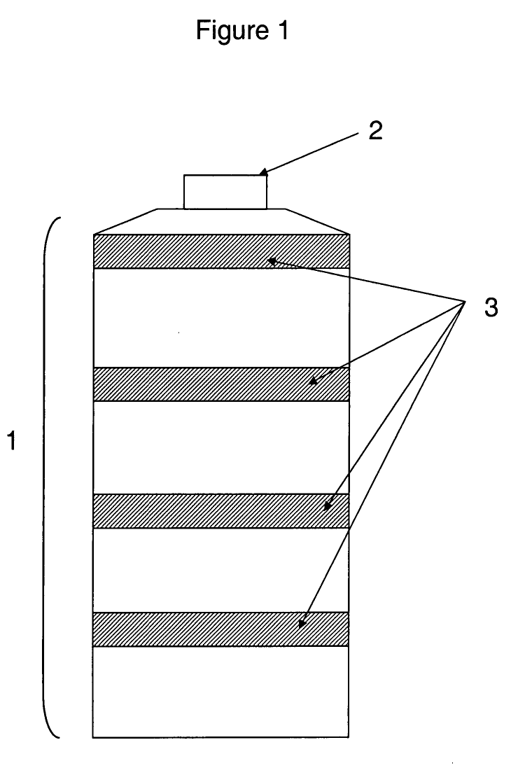

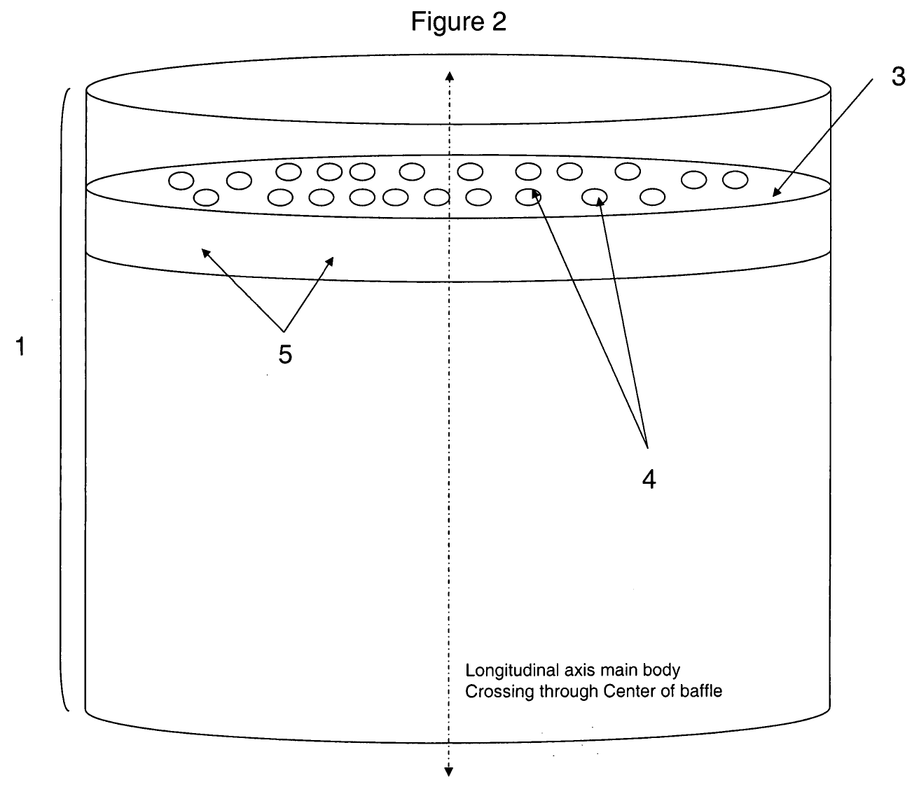

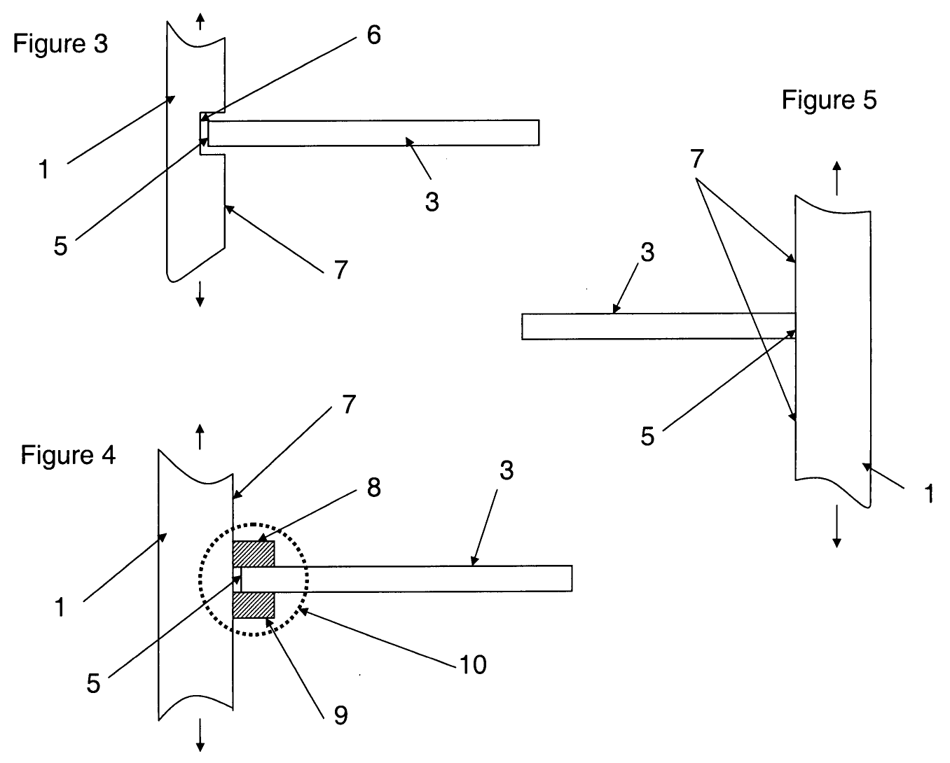

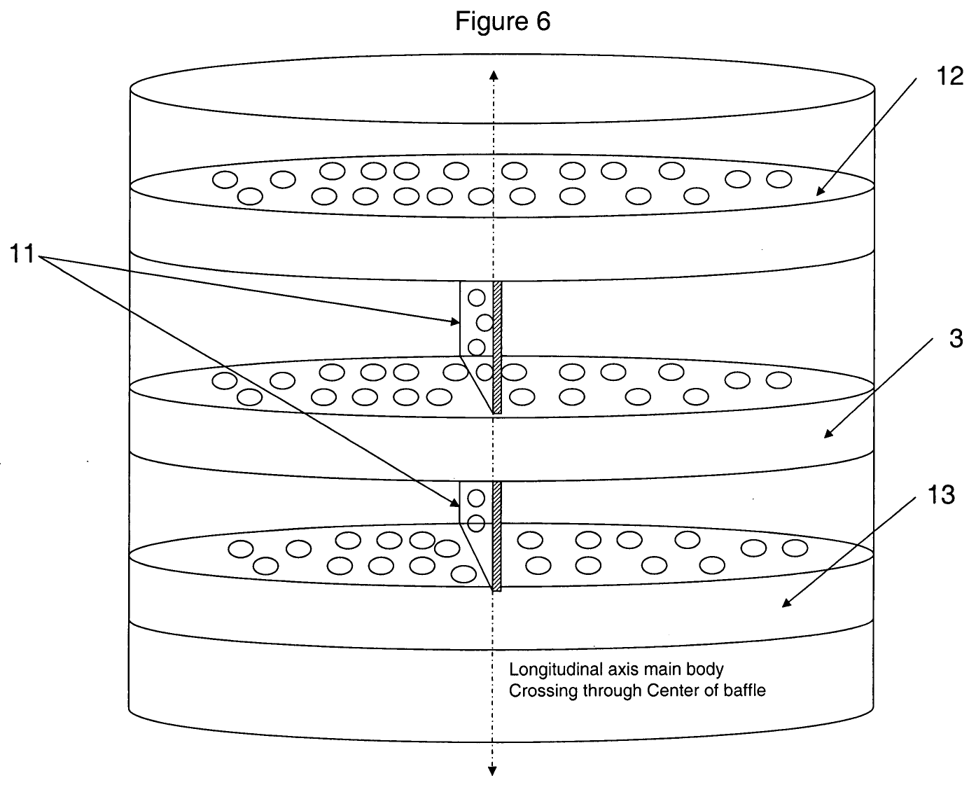

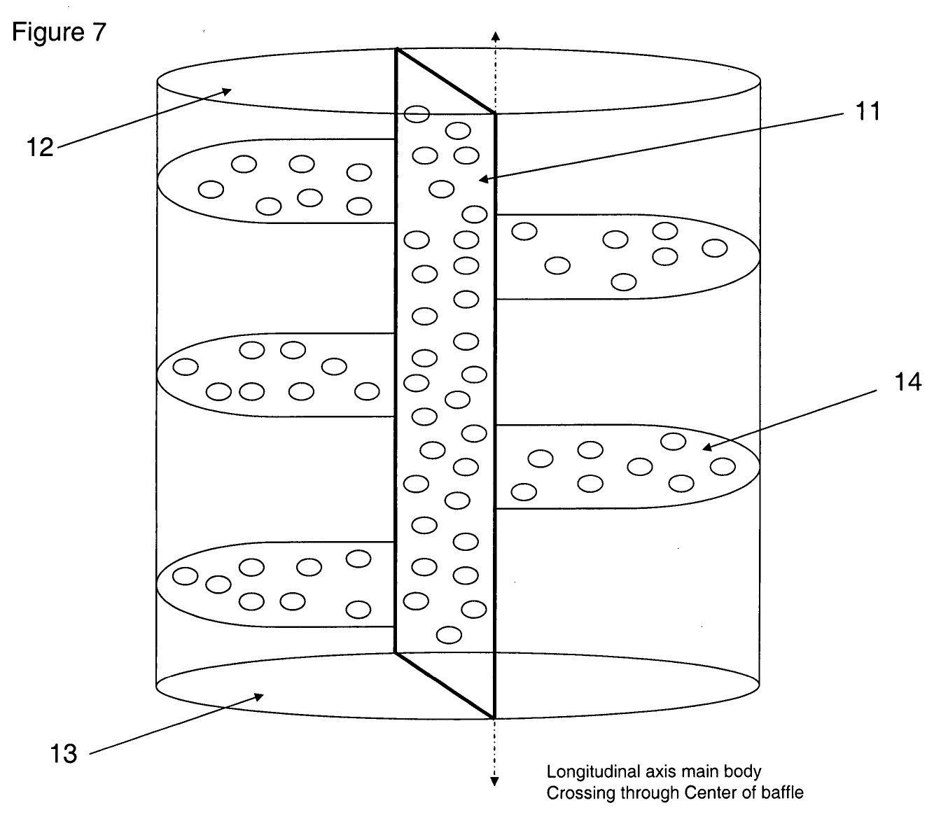

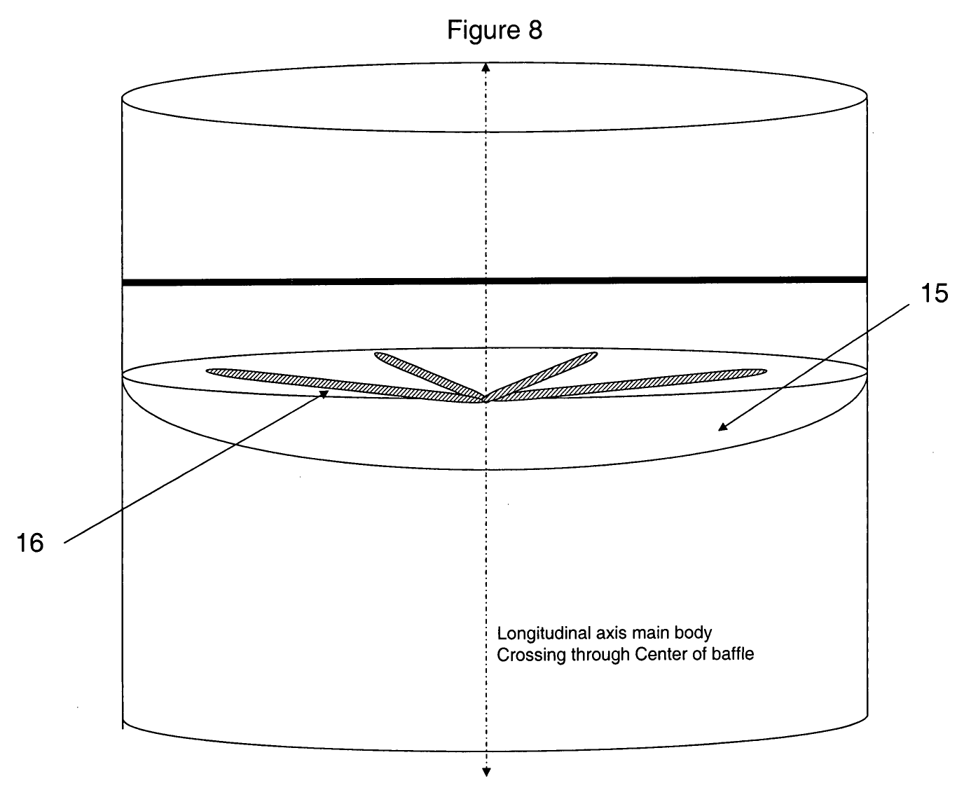

### DETAILED DESCRIPTION OF THE PRERRED EMBODIMENT

In the preferred embodiment the main body [1] of the water bottle is constructed of semi-rigid material. The water bottle maintains it's shape unless the athlete is squeezing the bottle to expel fluid through the spout [2] at one end of the bottle. The spout [2] is of a design typical to water bottles for runners where the fluid does not spill while running but easily allow fluid to exit under the slight pressure of the runner squeezing the bottle. There are 3 baffles [3], each baffle [3] is approximately disk shaped and each has a number of baffle openings [4] passing through it. Each baffle [3] is located so that it is perpendicular to the longitudal axis of the main body [1].

Each baffle [3] is semi-rigid such that they each retain their shape unless the athlete is squeezing the water bottle. Under this force the baffles [3] change shape while maintaining their direct attachment to the inner wall [7] of the main body [1]. Each baffles [3] circumscribing outer rim [5] is permanently affixed to the inner wall [7] of the main body [1]. The baffles [3] are located equidistant between the spout [2] at one end and the bottom of the water bottle at the other end.

In another form, the baffles [3] are attached to the main body [1] by locating the circumscribing outer rim [5] within a baffle receptacle [6] formed by a groove around the inner wall [7] of the main body [1] . In another form, the baffles [3] are attached to the main body [1] by locating the circumscribing outer rim [5] between a baffle ledge pair [10] formed by an upper baffle ledge [8] and a lower baffle ledge [9]. The upper baffle ledge [8] and a lower baffle ledge [9] are equidistant while circumscribing the inner wall [7] of the main body [1]. The distance of separation between upper baffle ledge [8] and a lower baffle ledge [9] is slightly greater than the thickness of a baffle [3].

I claim:

1. A beverage container comprising:
A main body with a: longitudinal axis, an inner wall and a spout at one end; and
a number of baffles; each baffle has a circumscribing outer rim connected to the inner wall of the main body, so that each baffle is perpendicular to the longitudal axis of the main body; each baffle has a number of baffle openings:

2. The beverage container of claim 1, where the connection of the inner wall of the main body to the circumscribing outer rim of each baffle comprises:
a number of baffle receptacles, each baffle receptacle consisting of a groove circumscribing the inner wall of the main body;
and
the circumscribing outer rim of each baffle, where each circumscribing outer rim is located within one baffle receptacle, so that there is one baffle outer rim located in each baffle receptacle.

3. The beverage container of claim 1, where the connection of the inner wall of the main body to the circumscribing outer rim of each baffle comprises:
baffle ledge pairs comprising:
an upper baffle ledge circumscribing the inner wall of the main body and a lower baffle ledge circumscribing the inner wall of the main body below the upper baffle ledge, where the distance between the upper baffle ledge and lower baffle ledge is very slightly greater than the thickness of a baffle;
and
the circumscribing outer rim of each baffle, where the circumscribing outer rim is located between an upper baffle ledge and lower baffle ledge, so that there is one baffle outer rim located in each baffle ledge pair.

4. The beverage container of claim 1, where the connection of the inner wall of the main body to the circumscribing outer rim of each baffle comprises:
a permanent or semi-permanent adhesive attaching each baffle's circumscribing outer rim to the inner wall of the main body, where such adhesive can not introduce toxic substances into the fluid in the beverage container.

5. The beverage container of claim 1, where the connection of the inner wall of the main body to the circumscribing outer rim of each baffle comprises:
each baffle's circumscribing outer rim fused to the inner wall of the main body.

6. The beverage container of claim 1 where the connection of the inner wall of the main body to the circumscribing outer rim of each baffle comprises:
each baffle's circumscribing outer rim integral to the inner wall of the main body.

7. A beverage container comprising:
A main body with a: longitudinal axis, inner wall and a spout at one end, where the main body is semi-rigid maintaining its shape unless force is applied to expel fluid through the spout;
and
a number of baffles; where each baffle is semi-rigid, maintaining its shape unless force is applied to the main body, under application of force each baffle flexes;
where each baffle has a circumscribing outer rim connected to the inner wall of the main body, so that each baffle is perpendicular to the longitudal axis of the main body prior to application of force to the main body, each baffle flexes under application of force while maintaining it's connection to the main body;
where each baffle has a number of baffle openings.

8. The beverage container of claim 7, where the connection of the inner wall of the main body to the circumscribing outer rim of each baffle comprises:
a number of baffle receptacles, each baffle receptacle consisting of a groove circumscribing the inner wall of the main body;
and
the circumscribing outer rim of each baffle, where each circumscribing outer rim is located within one baffle receptacle, so that there is one baffle outer rim located in each baffle receptacle.

9. The beverage container of claim 7, where the connection of the inner wall of the main body to the circumscribing outer rim of each baffle comprises:
baffle ledge pairs comprising:
an upper baffle ledge circumscribing the inner wall of the main body and a lower baffle ledge circumscribing the inner wall of the main body below the upper baffle ledge, where the distance between the upper baffle ledge and lower baffle ledge is very slightly greater than the thickness of a baffle;
and
the circumscribing outer rim of each baffle, where the circumscribing outer rim is located between an upper baffle ledge and lower baffle ledge, so that there is one baffle outer rim located in each baffle ledge pair.

10. The beverage container of claim 7, where the connection of the inner wall of the main body to the circumscribing outer rim of each baffle comprises:
a permanent or semi-permanent adhesive attaching each baffle's circumscribing outer rim to the inner wall of the main body, where such adhesive can not introduce toxic substances into the fluid in the beverage container.

11. The beverage container of claim 7, where the connection of the inner wall of the main body to the circumscribing outer rim of each baffle comprises:
each baffle's circumscribing outer rim fused to the inner wall of the main body.

12. The beverage container of claim 7, where the connection of the inner wall of the main body to the circumscribing outer rim of each baffle comprises:
each baffle's circumscribing outer rim integral to the inner wall of the main body.

13. A beverage container comprising:
A main body with a: longitudinal axis, an inner wall and a spout at one end, where the main body is semi-rigid maintaining its shape unless force is applied to expel fluid through the spout;
and
a number of baffles; where each baffle is semi-rigid, maintaining its shape unless force is applied to the main body, under application of force each baffle flexes;
where each baffle has a circumscribing outer rim connected to the inner wall of the main body, so that each baffle is perpendicular to the longitudal axis of the main body prior to application of force to the main body, each baffle flexes under application of force while maintaining it's connection to the main body; where each baffle has a number of baffle openings;
and a top baffle which is semi-rigid with a circumscribing outer rim attached to the inner wall of the main body, the top baffle is the closest baffle to the bottle spout and is perpendicular to the longitudal axis of the main body prior to application of force to the main body, the baffle flexes under application of force while maintaining it's connection to the inner wall of the main body; where the baffle has a number of baffle openings;
and a bottom baffle which is semi-rigid with a circumscribing outer rim attached to the inner wall of the main body, the bottom baffle is the furthest baffle from the bottles spout and is perpendicular to the longitudal axis of the main body prior to application of force to the main body, the baffle flexes under application of force while maintaining it's connection to the main body; where the baffle has a number of baffle openings;
and a number of longitudal baffles, whose long axis are located parallel to the longitudal axis of the main body, each longitudal baffle has a top surface connected to either a baffle or top baffle, each longitudal baffle has a bottom surface connected to either a baffle or a bottom baffle.

14. A beverage container comprising:
A main body with a: longitudinal axis, and inner wall and a spout at one end, where the main body is semi-rigid maintaining its shape unless force is applied to expel fluid through the spout;
and
and a top baffle which is semi-rigid with a circumscribing outer rim attached to the inner wall of the main body, the top baffle is the closest baffle to the bottle spout and is perpendicular to the longitudinal axis of the main body prior to application of force to the main body, the baffle flexes under application of force while maintaining it's connection to the inner wall of the main body; where the baffle has a number of baffle openings;
and a bottom baffle which is semi-rigid with a circumscribing outer rim attached to the inner wall of the main body, the bottom baffle is the furthest baffle from the bottles spout and is perpendicular to the longitudinal axis of the main body prior to application of force to the main body, the baffle flexes under application of force while maintaining it's connection to the main body; where the baffle has a number of baffle openings;
and a longitudinal baffle, whose long axis is parallel to the longitudal axis of the main body, the longitudal baffle has a top surface connected to the top baffle, each longitudal baffle has a bottom surface connected to the bottom baffle.
a number of half baffles; where each half baffle is semi-rigid, roughly semi-circular in shape, maintaining its shape unless force is applied to the main body, under application of force each half baffle flexes;
each half baffle has a circumscribing outer rim connected to the inner wall of the main body, so that each baffle is perpendicular to the longitudal axis of the main body prior to application of force to the main body, each baffle flexes under application of force while maintaining it's connection to the main body; where each baffle has a number of baffle openings;
and
each half baffle has a flat inner rim rigidly attached to the longitudal baffle.

15. A beverage container comprising:
A main body with a: longitudinal axis, an inner wall and a spout at one end, where the main body is semi-rigid maintaining its shape unless force is applied to expel fluid through the spout;
and
a number of non-planar baffles; where each non-planar baffle is semi-rigid, maintaining its shape unless force is applied to the main body, under application of force each non-planar baffle flexes, each non-planar baffle is shaped roughly like a cup;
where each non-planar baffle has a circumscribing outer rim connected to the inner wall of the main body, so that each non-planar baffle is perpendicular to the longitudal axis of the main body prior to application of force to the main body, each non-planar baffle flexes under application of force while maintaining it's connection to the main body;
where each non-planar baffle has a number of elongated baffle openings.

16. The beverage container of claim 15, where the connection of the inner wall of the main body to the circumscribing outer rim of each non-planar baffle comprises:
a number of baffle receptacles, each baffle receptacle consisting of a groove circumscribing the inner wall of the main body;
and
the circumscribing outer rim of each non-planar baffle, where each circumscribing outer rim is located within one baffle receptacle, so that there is one baffle outer rim located in each baffle receptacle.

17. The beverage container of claim 15, where the connection of the inner wall of the main body to the circumscribing outer rim of each non-planar baffle comprises:
baffle ledge pairs comprising:
an upper baffle ledge circumscribing the inner wall of the main body and a lower baffle circumscribing the inner wall of the main body below the upper baffle ledge, where the distance between the upper baffle ledge and lower baffle ledge is very slightly greater than the thickness of a baffle;
and
the circumscribing outer rim of each non-planar baffle, where the circumscribing outer rim is located between an upper baffle ledge and lower baffle ledge, so that there is one baffle outer rim located in each baffle ledge pair.

18. The beverage container of claim 15, where the connection of the inner wall of the main body to the circumscribing outer rim of each non-planar baffle comprises:
a permanent or semi-permanent adhesive attaching each non-planar baffle's circumscribing outer rim to the inner wall of the main body, where such adhesive can not introduce toxic substances into the fluid in the beverage container.

19. The beverage container of claim 15, where the connection of the inner wall of the main body to the circumscribing outer rim of each non-planar baffle comprises:
each non-planar baffle's circumscribing outer rim fused to the main body.

20. The beverage container of claim 15, where the connection of the inner wall of the main body to the circumscribing outer rim of each non-planar baffle comprises:
each non-planar baffle's circumscribing outer rim integral to the inner wall of the main body.
